(19) United States
(12) Patent Application Publication
(10) Pub. No.: US 2004/0016126 A1
(43) Pub. Date: Jan. 29, 2004

(54) Manually adjustable hair removal and skin lubrication

(76) Inventor: Bryan P. deBlois, Guildford, CT (US)

Correspondence Address: Gregg C. Benson, Pfizer Inc., Patent Department, MS 4159, Eastern Point Road, Groton, CT, 06340, US

(21) Appl. No.: 10/295,667

(22) Filed: Nov. 15, 2002

(30) Foreign Application Priority Data
Jul. 29, 2002 (EP) 02016832.4

(51) Int. Cl. B26B 19/40

(52) U.S. Cl. 30/41; 30/34.05

(57) ABSTRACT

A hand held dual purpose hair removal and skin lubrication device has a U-shaped resilient body. One leg of the U fits the user's thumb, and the other leg of the U fits one or more opposing fingers. The device can be manipulated to expel lubricant from an internal reservoir, or to operate only the razor head. Both the razor head and the lubrication can be done in a third mode operation.

This invention relates generally to a hand-held device that serves multiple purposes, namely, hair removal, and the applying of lubricant to the skin or hair. More particularly this invention relates to a device which also allows simultaneous operation of both the hair removal means and the applicator.

### BACKGROUND OF THE INVENTION

Hand-held wet safety razors generally require elongated handles that are designed to be gripped by the user in operating the razor.

Also available are applicator pads intended to lubricate the skin and/or the hair to be cut. These applicator pads may or may not require handles, and may or may not be used as a preliminary step to step of the actual shaving.

### SUMMARY OF THE INVENTION

The present invention seeks to eliminate the need for both a hand-held razor and separate lubricant applicator by providing a single hand-held device for applying the fluid lubricant and for the hair removal or shaving step. These capabilities are provided in a device that can carry out both functions simultaneously. The present invention includes a U-shaped applicator body having a size and shape such that the device fits into the hand of the user with the legs of the U-shaped device engaged by one's thumb and one's index and forefinger respectively.

One leg of the applicator body defines a resiliently deformable reservoir for storing a fluid lubricant, and that also includes an applicator pad of porous material provided on the end of that leg so that fluid from the reservoir can be wicked or squeezed from the reservoir into the applicator pad and thence onto the hair or skin of the user.

The other leg of the U-shaped body is designed to support a hair removal means such as an articulated razor head which allows the hair removal means to be used separately, or in conjunction with the hair/skin applicator pad, so that either of these can be selectively used simply by changing the angle or orientation of the device relative to the part of the body which is being treated or can be used simultaneously.

### BRIEF DESCRIPTION OF THE DRAWINGS

FIG. 1 is a perspective view illustrating use of the device as an applicator, the device being held in the user's hand between the thumb and/or the forefinger and index finger for applying lubricant to one's skin.

FIG. 2 shows the same device held at a slightly different angle to the skin surface being treated so that the applicator pad is used in a matter similar to FIG. 1, but so that the hair removal means mounted to the other leg of the U-shaped device functions in such a manner as to shave or remove hair from that skin after application of the lubricant.

FIG. 3 shows the device of FIGS. 1 and 2, but held in a configuration and angles relative to the skin surface being treated so that the applicator pad is not in contact with the skin, but only the hair removal means or razor device is in contact with the skin.

FIG. 4 is a photo showing the device in use.

### DETAILED DESCRIPTION

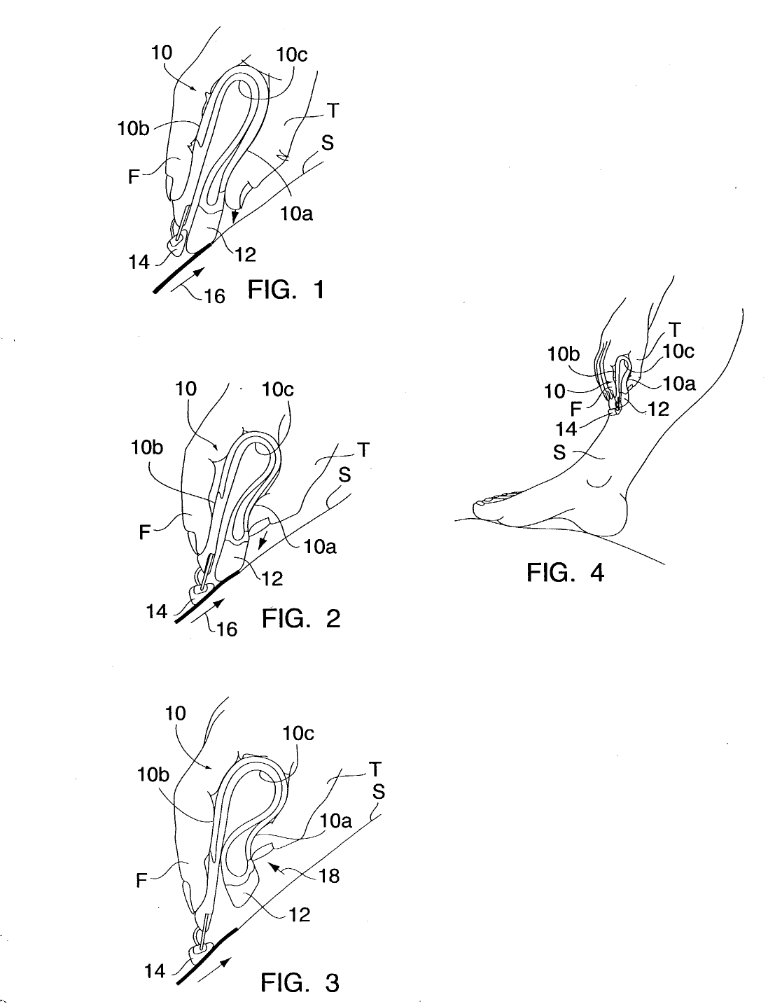

Turning now to the drawings in greater detail, and referring first to FIG. 1, the applicator device of the present invention can be seen to have a generally U-shape so as to fit within the hand of the user in a configuration such that the base 10c of the U is engaged by the palm of the hand, and one leg 10a of the U is adapted to be engaged by the user's thumb. The index finger and/or the forefinger of the hand are adapted to engage the opposite leg 10b of the U-shaped device so that the device can be held in a convenient manner for use in any of the three modes of operation to be described.

The U-shaped body 10 is preferably formed from a resiliently flexible synthetic material which is molded to define a hollow portion at least in the one leg 10a engaged by the thumb T so as to define a reservoir that is filled with a fluid lubricant. A wicking device or applicator sponge is provided at the end of the one leg engaged by the thumb, as indicated generally at 12, and communicates with the applicator fluid in the reservoir so as to draw fluid from the reservoir either by capillary action and/or as aided by gravity as the device is drawn in the direction of the arrow in FIG. 1 to apply fluid lubricant to the skin S or to the hair on the skin. It is an important feature of the present invention that the thumb T can be used to put pressure on the envelope defining the reservoir in this leg of the U-shaped body so as to allow the user to meter the fluid lubricant delivered to the applicator pad 12, and provided on the skin S.

Preferably, and as shown in FIG. 4, the U-shaped body has a width of approximately one to as much as two inches, and the base of the U-shaped device fits in the palm of the hand. The portion of the opposed leg 10b engaged by the finger F may be used to store a substantial quantity of such fluid lubricant. By applying pressure between the thumb and forefinger against the resiliently deformable U-shaped body one can discharge substantially all of the liquid lubricant from the internally defined reservoir in much the same manner as a toothpaste tube is squeezed by the user to discharge toothpaste from the tube onto a toothbrush.

With further reference to the opposed or second leg 10b of the U-shaped body, it will be apparent that the lower portion thereof is formed to provide a convenient surface against which the user's finger can act to provide the wiping action required of the applicator, as depicted in FIG. 1 and FIG. 4.

As best shown in FIG. 2 the opposed leg 10b and more particularly the end portion thereof is fitted with a hair removal means 14 in the form of an articulated razor head, much like that currently provided in a conventional hand-held razor. The user can orient the device in such a way as to present to the skin surface being treated, both the head of the razor 14 and the applicator pad 12 as best shown in FIG. 2. The end portion of the opposite leg 10b or the U-shaped body is configured to receive a disposable razor head, but the present invention does not require such a feature and the present invention can be realized in a device which is intended to be disposable once the hair removal means and/or the contents of the reservoir have been depleted or otherwise reached the end of their useful life. Hair removal means other than the head 14 can be employed at the end of the leg 10b.

Referring next to FIG. 3, the user is shown as providing the device in an orientation relative to the surfaces being treated that only the hair removal means 14 or shaving head is in contact with the skin. It will be apparent that the present invention can therefore be utilized in three different modes of operation, without requiring that the user employ a variety of devices to treat the hair and/or skin, and remove hair in the process of fulfilling his or her personal hygiene requirements.

In operation, the U-shaped device 10 can be manually manipulated by the user as follows. The thumb can be pushed downwardly in the direction of the arrow 16 of FIG. 4 to avoid any contact between the razor head 14 and the skin S.

Alternatively, if the thumb is moved upwardly as suggested by the arrow 18 in FIG. 3, only the razor head 14 will contact the user's skin S.

I claim:

1. A hand-held hair removal and skin lubrication device comprising:
a U-shaped body having a size and shape such that the legs of the u can be engaged by one's thumb and one or more fingers of one hand,
said U-shaped body having one leg that fits a user's thumb, and an opposed leg that fits one or more of the fingers, the base of the leg fitting the palm of the user's hand, said one applicator leg defining a resiliently deformable reservoir for storing a fluid lubricant, and an applicator pad of porous material communicating with said reservoir to receive the fluid squeezed from the reservoir by thumb pressure, and
said opposite u-shaped body leg for engagement by at least one of the fingers defining a holder for receiving hair removal means, and hair removal means so oriented on said opposed leg of said u-shaped holder as to allow use of: only said hair removal means, or only said fluid applicator, or both said hair removal means and said fluid applicator simultaneously.

2. The device according to claim 1 wherein said body is fabricated from a resiliently deformable synthetic material.

3. The device according to claim 2 wherein said one leg is shorter than said opposed leg in order to allow operating said device on the user's body surface at an angle between 30 and 60° relative to the body surface.

4. The device according to claim 3 wherein said U-shaped body defines said reservoir not only in the region of said one leg, but also in the region of said u-shaped body base adjacent the palm of the user's hand.

5. The device according to claim 4 wherein said reservoir is further defined at least in part by said opposed leg of said U-shape device.

6. The device according to claim 1 wherein said hair removal means is removably received on the end portion of said opposed leg for convenient replacement by another hair removal device.

7. The device according to claim 6 wherein said hair removal means comprises an articulated shaving head.

8. The device according to claim 1 wherein said opposed leg of said U-shaped device is longer than said one leg, and includes a relatively rigid portion that includes an inside surface adapted to be engaged by the end portion of the one leg during operation of said hair removal means.

9. The device according to claim 7 wherein said U-shaped body portion is fabricated from a synthetic material which defines an internal reservoir that extends from the one leg to said base to at least a portion of said opposed leg, which reservoir defining portion is resiliently deformable relative to said above-mentioned rigid portion of said opposed leg.
